(19) United States
(12) Patent Application Publication
(10) Pub. No.: US 2012/0231224 A1
(43) Pub. Date: Sep. 13, 2012

(54) WATERPROOF COMPOSITE MATERIAL

(76) Inventor: Hong-Ming Wu, Sanchung City (TW)

(21) Appl. No.: 13/045,802

(22) Filed: Mar. 11, 2011

(51) Int. Cl. B32B 7/04; B32B 27/00; B32B 9/02; B32B 5/18; B32B 3/30; B32B 3/10

(52) U.S. Cl. 428/172; 428/200; 428/221; 428/473; 428/317.3

(57) ABSTRACT

A waterproof composite material includes a substrate and a thermoplastic film. The substrate has an inner surface and an outer surface. The thermoplastic film has a waterproof property and has an inner surface and an outer surface. The inner surface of the thermoplastic film and the outer surface of the substrate form thermal fusion. When the thermoplastic film and the substrate are thermally fused together, a pressure is applied to the outer surface of the thermoplastic film. According to the above-mentioned structure, the firm combination, the smooth surface, the simple and quick manufacturing processes and the reduction of environment contamination can be obtained.

### BACKGROUND OF THE INVENTION

1. Field of the Invention

The invention relates to the technological field of a waterproof material, and more particularly to a waterproof composite material, which has the firm combination and the smooth surface, can reduce the environment contamination, and can be manufactured simply and quickly.

2. Description of the Prior Art

At present, among the frequently seen daily supplies, some articles are made of the material without the waterproof property but are often used to contact the water. For example, the articles may include the raincoat worn in the rainy day, the snowsuit, the exposure suit and the mountain climbing clothes or the like worn in climbing the mountain, and the diving suit worn in diving. The zipper on the zipper cloth sewed to the clothes or suit must have the good waterproof property. In addition, the typical sofa, seat cushion, luggage, briefcase and the like often have to be scrubbed by water or are often poured by water, and thus have to possess the good waterproof property. Because the articles themselves are made of the cloth material, leather or the like, which does not have the waterproof property, a waterproof film is attached to the surface of the manufactured material to have the waterproof property and become the waterproof material.

A conventional waterproof material, as shown in FIGS. 1 and 2, mainly includes a substrate 10, such as a cloth material, leather or the like, with the waterproof property. An outer surface 100 of the substrate 10 is firstly coated with a layer of binder 11, and then a waterproof film 12 with the waterproof property is provided to cover the outer surface 100 of the substrate 10, so that the binder 11 adheres the outer surface 100 of the substrate 10 to an inner surface 120 of the waterproof film 12. However, using this binder 11 as a medium to adhere the substrate 10 to the waterproof film 12 has the poor structural strength of combination, and the moisture tends to invade into the junction therebetween and thus to cause the detachment. More particularly, its manufacturing processes are more complicated and time-consuming. In addition, when the binder 11 adheres the waterproof film 12 to the substrate 10, the inner surface 120 of the waterproof film 12 tends to become unsmooth due to the material texture of the substrate 10. Furthermore, using the binder 11 as the medium to adhere the substrate 10 to the waterproof film 12 also cannot form a three-dimensional pattern on the inner surface 120 of the waterproof film 12, so its pattern is more monotonous. More particularly, the currently available binder 11 has the volatile and toxic organic solvent, and thus causes the relatively serious contamination to the environment.

In view of this, the invention has been proposed to solve the above-mentioned problems after the advanced ideas and improvements have been made.

### SUMMARY OF THE INVENTION

It is therefore a main object of the invention to provide a waterproof composite material, which has the firm combination and the smooth surface, can reduce the environment contamination, and can be manufactured simply and quickly.

More specifically, the waterproof composite material of the invention includes a substrate and a thermoplastic film. The substrate has an inner surface and an outer surface. The thermoplastic film has a waterproof property, an inner surface and an outer surface. The inner surface of the thermoplastic film and the outer surface of the substrate form thermal fusion, and a pressure of rolling, hot pressing or leveling is applied to the outer surface of the thermoplastic film when the thermoplastic film and the substrate are thermally fused.

The inner surface of the thermoplastic film and the outer surface of the substrate are thermally fused, and some chemical molecules of the thermoplastic film and the substrate form links due to the high temperature when being thermally fused, or even a portion of the thermoplastic film penetrates into the pores of the substrate. Therefore, the thermoplastic film and the substrate may be combined firmly. In addition, when the inner surface of the thermoplastic film and the outer surface of the substrate are thermally fused, the outer surface of the thermoplastic film also forms the half-fused state due to the high temperature. At this time, the pressure of rolling, hot pressing or leveling pressure on the outer surface of the thermoplastic film makes the manufacturing process become simpler and rapider because the outer surface of the thermoplastic film is smoother. In addition, the thermoplastic film and the substrate are combined by way of thermal fusion in this invention, so the volatile and toxic organic solvent serving as the adhesive agent for manufacturing the conventional waterproof material need not to be used, and the environment contamination can be reduced according to this invention.

In this invention, a hot air steam may be firstly blown to the inner surface of the thermoplastic film to make the thermoplastic film become a fused state, and then the fused state thermoplastic film covers the outer surface of the substrate. Next, the substrate and the thermoplastic film, which are laminated, are transported through an upper pressing roller and a lower pressing roller, which are rotatable relatively to each other. The upper and lower pressing rollers roll and clamp the thermoplastic film to make the inner surface of the thermoplastic film and the outer surface of the substrate form the thermal fusion.

In this invention, the thermoplastic film may cover the outer surface of the substrate, and then the substrate and the thermoplastic film are transported through the upper pressing roller and the lower pressing roller, which are rotatable relatively to each other. The upper pressing roller has a high temperature and presses against the outer surface of the thermoplastic film, the lower pressing roller presses against the inner surface of the substrate, and the upper and lower pressing rollers roll and clamp the substrate and the thermoplastic film to make the inner surface of the thermoplastic film and the outer surface of the substrate form the thermal fusion.

In this invention, the substrate may be transported through an upper pressing roller and a lower pressing roller, and then an extruder extrudes a fused state thermoplastic material onto the upper side surface of the upper pressing roller, so that the thermoplastic material is brought to the upper surface of the substrate with the rotation of the upper pressing roller. The upper and lower pressing rollers roll and clamp the substrate and the fused state thermoplastic film to make the fused state thermoplastic material form the thermoplastic film on the outer surface of the substrate, and make the inner surface of the thermoplastic film and the outer surface of the substrate form the thermal fusion.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematically pictorially exploded view showing a conventional waterproof material.

FIG. 2 is a schematically partially enlarged view showing the conventional waterproof material.

FIG. 3 is a schematically pictorially exploded view showing a waterproof composite material of the invention.

FIG. 4 is a schematically partially enlarged view showing the waterproof composite material of the invention.

FIG. 5 is a schematic illustration showing a first manufacturing process of the invention.

FIG. 6 is a schematic illustration showing a second manufacturing process of the invention.

FIG. 7 is a schematic illustration showing a third manufacturing process of the invention.

FIG. 8 shows a second aspect of the invention.

FIG. 9 shows a third aspect of the invention.

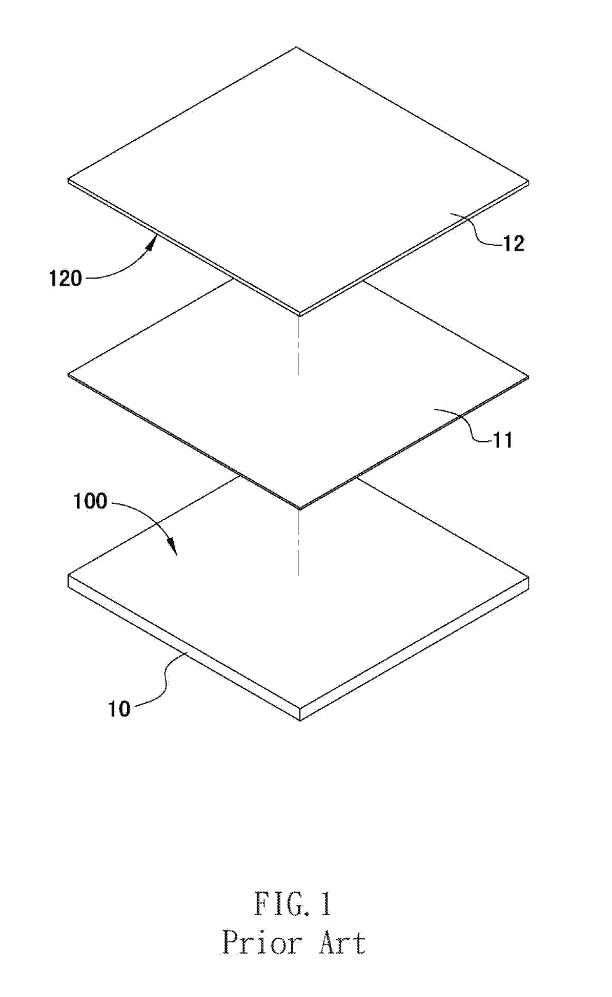

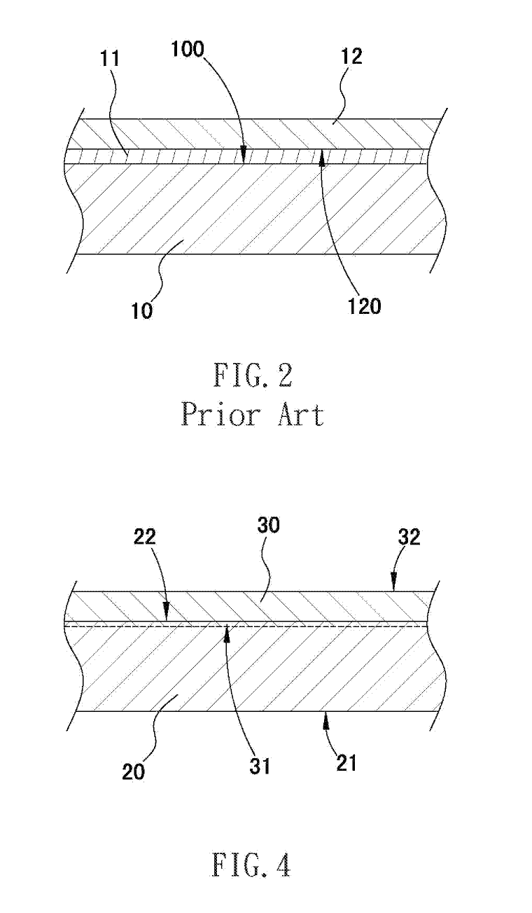

### DETAILED DESCRIPTION OF THE PREFERRED EMBODIMENTS

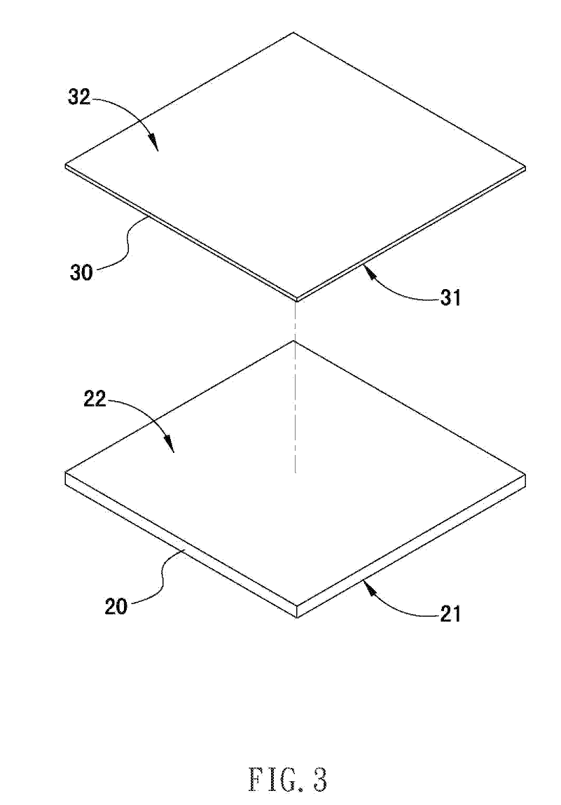

Referring to FIGS. 3 and 4, a waterproof composite material of the invention includes a substrate 20 and a thermoplastic film 30.

The substrate 20 may be a cloth material, leather, a foaming material, or the like, and has an inner surface 21 and an outer surface 22.

The thermoplastic film 30 is made of a thermoplastic material with a waterproof property, and has an inner surface 31 and an outer surface 32. The inner surface 31 of the thermoplastic film 30 and the outer surface 22 of the substrate 20 form thermal fusion, and a pressure is applied to the outer surface 32 of the thermoplastic film 30 when the thermoplastic film 30 and the substrate 20 are thermally fused together.

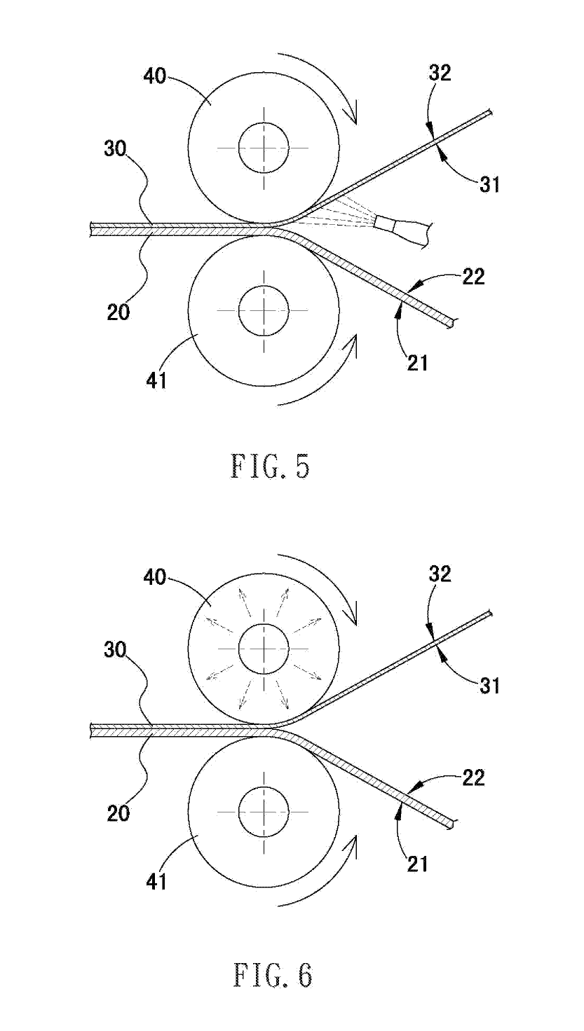

FIG. 5 is a schematic illustration showing a first manufacturing process of the invention. As shown in FIG. 5, a hot air steam is firstly blown to the inner surface 31 of the thermoplastic film 30 to make the thermoplastic film 30 become a fused state, and then the thermoplastic film 30 covers the outer surface 22 of the substrate 20. Then, the substrate 20 and the thermoplastic film 30, which are laminated, are transported through an upper pressing roller 40 and a lower pressing roller 41, which are rotatable relatively to each other. The upper pressing roller 40 and the lower pressing roller 41 roll and clamp the substrate 20 and the thermoplastic film 30 to form the firm thermal fusion between the inner surface 31 of the thermoplastic film 30 and the outer surface 22 of the substrate 20.

FIG. 6 is a schematic illustration showing a second manufacturing process of the invention. As shown in FIG. 6, the thermoplastic film 30 covers the outer surface 22 of the substrate 20, and then the substrate 20 and the thermoplastic film 30 are transported through the upper pressing roller 40 and the lower pressing roller 41, which are rotatable relatively to each other. The upper pressing roller 40 has a high temperature and presses against the outer surface 32 of the thermoplastic film 30, and the lower pressing roller 41 presses against the inner surface 21 of the substrate 20. The upper pressing roller 40 and the lower pressing roller 41 roll and clamp the substrate 20 and the thermoplastic film 30, so that the firm thermal fusion is formed between the inner surface 31 of the thermoplastic film 30 and the outer surface 22 of the substrate 20.

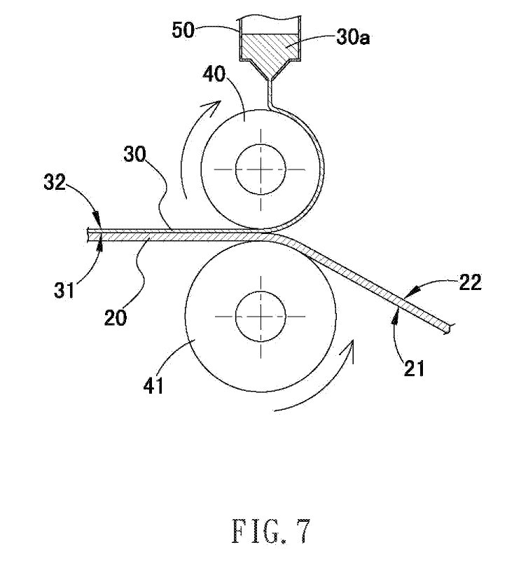

FIG. 7 is a schematic illustration showing a third manufacturing process of the invention. As shown in FIG. 7, the substrate 20 is transported through the upper pressing roller 40 and the lower pressing roller 41, which are rotatable relatively to each other. Then, an extruder 50 extrudes the fused state thermoplastic material 30a onto an upper side surface of the upper pressing roller 40, so that the thermoplastic material 30a is brought to the outer surface 22 of the substrate 20 with the rotation of the upper pressing roller 40. The upper pressing roller 40 and the lower pressing roller 41 roll and clamp the substrate 20 and the fused state thermoplastic material 30a to form the thermoplastic film 30 on the outer surface 22 of the substrate 20. In addition, the inner surface 31 of the thermoplastic film 30 and the outer surface 22 of the substrate 20 form the firm thermal fusion.

In this invention, when the thermoplastic film 30 and the substrate 20 are thermally fused together, the above-mentioned rolling method can be applied, and the pressure may also be applied to the outer surface 32 of the thermoplastic film 30 by way of entire-surface leveling or hot pressing.

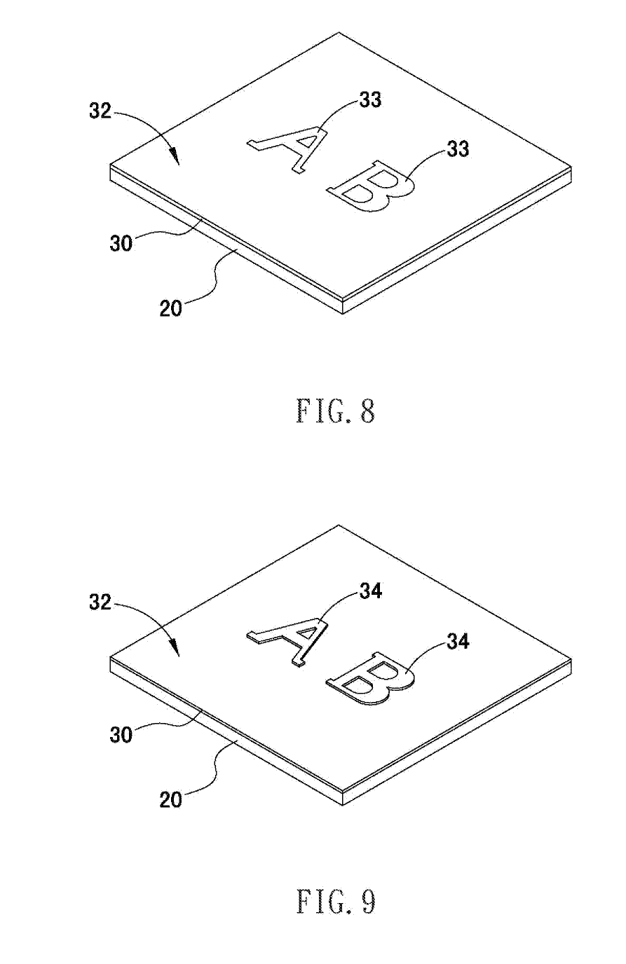

FIG. 8 shows a second aspect of the invention. As shown in FIG. 8, at least one pattern 33 may be printed on the outer surface 32 of the thermoplastic film 30 before or after the thermoplastic film 30 and the substrate 20 are thermally fused together.

FIG. 9 shows a third aspect of the invention. As shown in FIG. 9, a three-dimensional pattern (not shown) may be formed on the upper pressing roller 40 in the above-mentioned manufacturing processes. Thus, after the thermoplastic film 30 and the substrate 20 are rolled by the upper pressing roller 40 to form the thermal fusion, a corresponding three-dimensional pattern 34 is formed on the outer surface 32 of the thermoplastic film 30.

The inner surface 31 of the thermoplastic film 30 and the outer surface 22 of the substrate 20 are thermally fused, and some chemical molecules of the thermoplastic film 30 and the substrate 20 form links due to the high temperature when being thermally fused, or even a portion of the thermoplastic film 30 penetrates into the pores or knitting holes of the substrate 20. Therefore, the thermoplastic film 30 and the substrate 20 may be combined firmly. In addition, when the inner surface 31 of the thermoplastic film 30 and the outer surface 22 of the substrate 20 are thermally fused, the outer surface 32 of the thermoplastic film 30 also forms the half-fused state due to the high temperature. At this time, the pressure of rolling, hot pressing or leveling pressure on the outer surface 32 of the thermoplastic film 30 makes the manufacturing process become simple and rapid because the outer surface 32 of the thermoplastic film 30 is smoother. In addition, the thermoplastic film 30 and the substrate 20 are combined by way of thermal fusion in this invention, so the volatile and toxic organic solvent serving as the adhesive agent for manufacturing the conventional waterproof material need not to be used, and the environment contamination can be reduced. More particularly, when the waterproof composite material of the invention is manufactured, the three-dimensional pattern 34 can be easily formed on the half-fused state outer surface 32 of the thermoplastic film 30 using the upper pressing roller 40, and more pattern variations may be selected.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A waterproof composite material, comprising:
a substrate having an inner surface and an outer surface; and
a thermoplastic film having a waterproof property, an inner surface and an outer surface, wherein the inner surface of the thermoplastic film and the outer surface of the substrate form thermal fusion, and a pressure is applied to the outer surface of the thermoplastic film when the thermoplastic film and the substrate are thermally fused.

2. The waterproof composite material according to claim 1, wherein the inner surface of the thermoplastic film is firstly heated into a fused state, and then covers the outer surface of the substrate, and then the outer surface of the thermoplastic film is pressed so that the thermal fusion is formed between the inner surface of the thermoplastic film and the outer surface of the substrate.

3. The waterproof composite material according to claim 2, wherein a hot air steam is blown to the inner surface of the thermoplastic film to make the thermoplastic film become a fused state.

4. The waterproof composite material according to claim 3, wherein the substrate and the thermoplastic film, which are laminated, are transported through an upper pressing roller and a lower pressing roller, which are rotatable relatively to each other, and the upper and lower pressing rollers roll and clamp the thermoplastic film and the substrate to thermally fuse the inner surface of the thermoplastic film and the outer surface of the substrate together.

5. The waterproof composite material according to claim 1, wherein the thermoplastic film covers the outer surface of the substrate, and then the thermoplastic film and the substrate are transported through an upper pressing roller and a lower pressing roller, which are rotatable relatively to each other, wherein the upper pressing roller has a high temperature and presses against the outer surface of the thermoplastic film, the lower pressing roller presses against the inner surface of the substrate, and the upper and lower pressing rollers roll and clamp the thermoplastic film and the substrate to thermally fuse the inner surface of the thermoplastic film and the outer surface of the substrate together.

6. The waterproof composite material according to claim 1, wherein the substrate is transported through an upper pressing roller and a lower pressing roller, which are rotatable relatively to each other, and then an extruder extrudes a fused state thermoplastic material onto an upper side surface of the upper pressing roller, such that the thermoplastic material is brought to the outer surface of the substrate with rotation of the upper pressing roller, and the upper and lower pressing rollers roll and clamp the fused state thermoplastic material and the substrate to form a thermoplastic film on the outer surface of the substrate, and the inner surface of the thermoplastic film and the outer surface of the substrate are thermally fused together.

7. The waterproof composite material according to claim 4, wherein the upper pressing roller has a three-dimensional pattern, so that a three-dimensional pattern, corresponding to the three-dimensional pattern of the upper pressing roller, is formed on the outer surface of the thermoplastic film after the thermoplastic film and the substrate are thermally fused together.

8. The waterproof composite material according to claim 1, wherein the outer surface of the thermoplastic film is printed with a pattern.

9. The waterproof composite material according to claim 1, wherein the substrate may be a cloth material.

10. The waterproof composite material according to claim 1, wherein the substrate may be leather.

11. The waterproof composite material according to claim 1, wherein the substrate may be a foaming material.
